(19) United States
(12) Patent Application Publication
(10) Pub. No.: US 2005/0257437 A1
(43) Pub. Date: Nov. 24, 2005

(54) Method, system and article of manufacture for a modular room

(76) Inventors: Robert Juten, Duluth, MN (US); Zachary F. Richmond, Duluth, MN (US)

Correspondence Address: DARBY & DARBY P.C., P. O. BOX 5257, NEW YORK, NY, 10150-5257, US

(21) Appl. No.: 11/110,018

(22) Filed: Apr. 19, 2005

Related U.S. Application Data
(60) Provisional application No. 60/563,365, filed on Apr. 19, 2004.

(51) Int. Cl. A47F 10/00

(52) U.S. Cl. 52/36.1

(57) ABSTRACT

A modular space system comprising load bearing components designed with graphics software, manufactured with data from the graphics software, and assembled onto building frames. A user enters dimensions, materials, and other design parameters to generate a graphic rendition and prepare components. Load bearing walls, a floor, and a ceiling are assembled into a stand alone unit that can be attached to a building frame directly, such that the walls, floor, and/or ceiling are flush with, or naturally interface with other surfaces of the building, such as plasterboard walls. The unit can also be attached to the frames through an existing surface and/or to the existing surface. Interfaces between load bearing surfaces are precise, reducing the need for finish work, such as taping. The load bearing surfaces can support multi-position shelves, partitions, fixtures, etc. An opening is provided for walk-in or reach-in access to an interior of the modular space system.

### CROSS-REFERENCE TO RELATED APPLICATIONS

This application claims the benefit of U.S. Provisional Patent Application No. 60/563,365, filed Apr. 19, 2004, the contents of which are hereby incorporated by reference.

### FIELD OF THE INVENTION

The present invention is generally directed to a modular space in building construction with a method and system for making the modular space, and more particularly to a modular room comprising custom designed and prefabricated components that can be designed through intuitive software, manufactured with data from the software, and assembled onto building frames.

### BACKGROUND OF THE INVENTION

Conventional building techniques include on-site construction and factory manufacturing. On-site construction typically involves a large amount of manual labor, following a plan to construct a building from a supply of raw materials. The raw materials are usually individually cut and constructed into a load-bearing frame of floors, walls, and roof on a foundation at a building site. Internal spaces are usually completed at the building site with floor, wall, and ceiling surfaces that span the load-bearing frame elements. The surfaces create an enclosed space and hide the load-bearing frame elements. Wall and ceiling surfaces are often made of materials, such as plaster board, that are generally not designed to bear significant loads. Because these internal surfaces hide the load-bearing frame elements and are usually not intended to carry loads themselves, the internal surfaces make it difficult to add and/or rearrange shelves, cabinets, door jambs, clothing rods, ceiling fans, and other common internal elements that should be attached to load-bearing structures. The wall and ceiling surfaces also typically require taping, painting, and/or other finishing operations to blend intersecting surfaces and to provide an aesthetically pleasing appearance. Similarly, base boards are often used to blend intersections between walls and floors. These finishing operations add to the time and expense of manual labor.

Factory manufactured buildings are generally constructed at a facility away from the final building site. Components, such as wall frames, roof trusses, and other sub-assemblies are typically built from raw materials at the factory facility with automated machinery, reducing the amount of manual labor needed. The sub-assemblies are then assembled into the largest possible building component that can still be transported to the final building site. Such components are sometimes referred to as single-wide components. The large building components include complete internal spaces with floors, walls, ceilings, cabinets, counters, and most other components that complete the internal rooms. One or more single-wide components are then installed at the final building site. While automation is employed, the design and construction is typically done well before a buyer has an opportunity to request any customized configurations of the internal spaces and additional internal elements. Thus, the size, location, and configuration of the internal spaces are usually predefined. Some finishing operations are also often still needed after transporting the large building component(s) to the final building site.

Between the above two construction techniques are some sub-assemblies for installation on-site. For example, some shower units can be obtained as a single preformed unit or as a kit of parts, and installed on-site. However, these units typically have design limitations based on standards for drain locations, water line locations, and the like. Consequently, these units usually can not be selectively designed or otherwise customized by an individual buyer of a building. These units also do not usually include a way to reconfigure components after the units are installed. Other types of kits are simply inserts to be installed after conventional internal surfaces are built. For example, closet inserts and cabinets with adjustable shelves can be installed after the conventional floor, walls, and ceiling of an internal space are built. These inserts do not substantially reduce the amount of finish work required for the floors, walls, and ceiling.

### BRIEF DESCRIPTION OF THE DRAWINGS

FIG. 1 is an isometric view of an exemplary embodiment in the form of a storage space;

FIG. 2 is an opaque exploded view of a computer rendering of the storage space;

FIG. 3 is a transparent exploded view of the computer rendering of the storage space;

FIG. 4 is a front view of another exemplary embodiment in the form of a clothes closet;

FIG. 5 is an isometric view of a portion of the clothes closet;

FIG. 6 is a close up view of a different storage space that includes at least one fixed shelf that is positioned at a fixed location within the different storage space;

FIG. 7 is a flow diagram illustrating exemplary logic for designing and manufacturing a modular room;

FIG. 8 is a screen shot of an exemplary user interface for design software;

FIG. 9 is an introductory screen shot displayed upon initiation of the design software;

FIG. 10 is a block diagram illustrating an exemplary embodiment of a computer and/or controller according to one embodiment of the invention;

FIG. 11 illustrates one embodiment of an electronic network environment in which the present invention may operate;

FIG. 12 is a transparent perspective view of an embodiment of the invention with a configurable subfloor;

FIG. 13A is a transparent perspective view of another embodiment that includes a movable partition;

FIG. 13B is a magnified view of an area at which a partition interfaces with the floor;

FIG. 14A is a transparent perspective view of yet another embodiment that provides one or more moveable partitions that are coupled to adjacent surfaces rather than opposite surfaces;

FIG. 14B is a magnified view of an area at which a partition interfaces with the ceiling;

FIG. 14C is a magnified view of an area at which a partition couples to a railing;

FIG. 15A is a side view of another embodiment that couples a partition to a surface such as a back wall panel; and

FIG. 15B is an exploded view of an exemplary coupling that couples a partition into contact with a surface.

### DETAILED DESCRIPTION OF THE INVENTION

The present invention provides a hybrid approach to building construction that utilizes design and manufacturing automation, simplifies installation, and enables users to add and/or adjust internal components. Modular rooms and other internal spaces can be designed with customer input, and components are produced with automation techniques. The components can then be delivered to and installed at the building site on the frame elements to provide an internal space that is integrated with other internal spaces. Some finishing can be performed to aesthetically blend a modular room with adjacent modular rooms and/or conventional floors, walls, and/or ceiling. However, the amount of finishing work is significantly reduced, compared to performing finishing work for every internal surface. The components also provide load support to enable adding and/or rearranging other internal elements.

### Exemplary Embodiment as a Closet

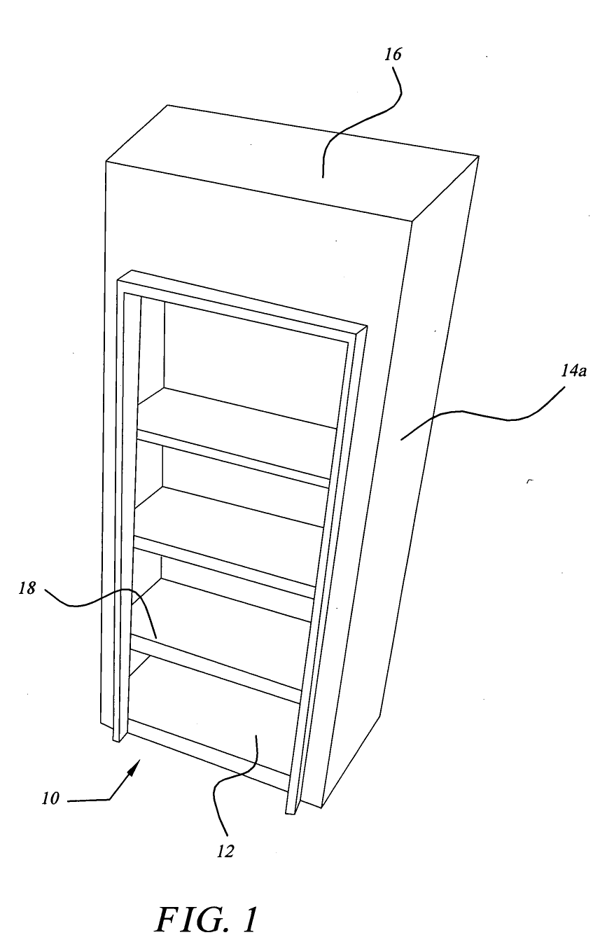

FIG. 1 is an isometric view of a simplified exemplary embodiment in the form of a storage space 10, such as a storage closet or a pantry. Storage space 10 comprises a number of static surfaces, including a floor 12, a side wall 14a, and a ceiling 16. When assembled together, the static surfaces define an enclosure that can stand on its own and at least partially enclose an interior space. One or more of the static surfaces can be freely supported by, or attached to, frame elements of the building. For instance, the unit can be attached directly to a floor frame such that the floor of the unit is flush with an adjacent floor. Alternatively, the unit can rest on an existing floor (or subfloor), and the walls can be attached to, or friction fit against, wall frames (e.g., directly or through a non-load bearing wall board). The static surfaces can also provide load-bearing capability for adjustable elements, such as an adjustable shelf 18. Fixed elements can also be supported by the static elements and/or the adjustable elements. For example, fixed elements may include ceiling lights, electrical outlets, overhead hooks, and the like. The static surfaces may be made of wood, a wood product, a composite, a metal, and/or other material capable of carrying sufficient load to the static surfaces and/or the adjustable elements.

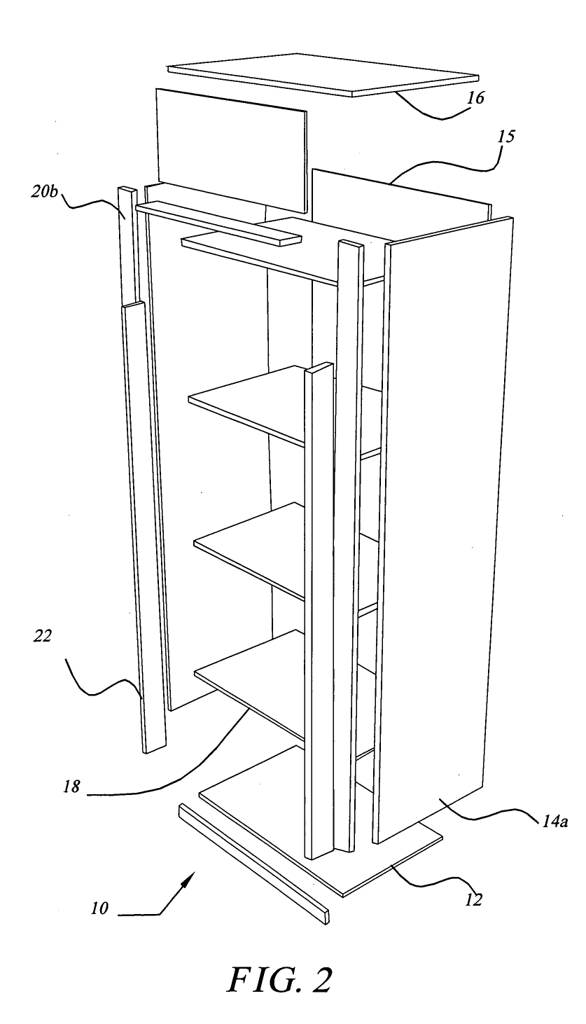

FIG. 2 is an opaque exploded view of a computer rendering of storage space 10. A user can input any desired dimensions, materials, configuration, and other design data into a software design system, which then generates component dimensions and other component data for each piece of the storage space. Software uses the generated component data to schedule cutting time, billing for the customer, material ordering and accounting information. The generated component data is also translated into computer numerical control (CNC) code and provided to one or more machines to produce each component. For example, floor 12, side wall 14a, back wall 15, ceiling 16, and shelf 18 can be prefabricated with a CNC machine from the component data and corresponding CNC code. These components and others, such as a front surface 20b, and doorjamb 22, can be prefabricated with holes, slots, and/or other characteristics for assembly and to support shelves and/or other components. The prefabricated components can also be sanded, painted, or otherwise finished with automated equipment at a factory. The components can then be shipped with associated joinery as a kit of unassembled components to the final building site for assembly and installation onto the frame elements.

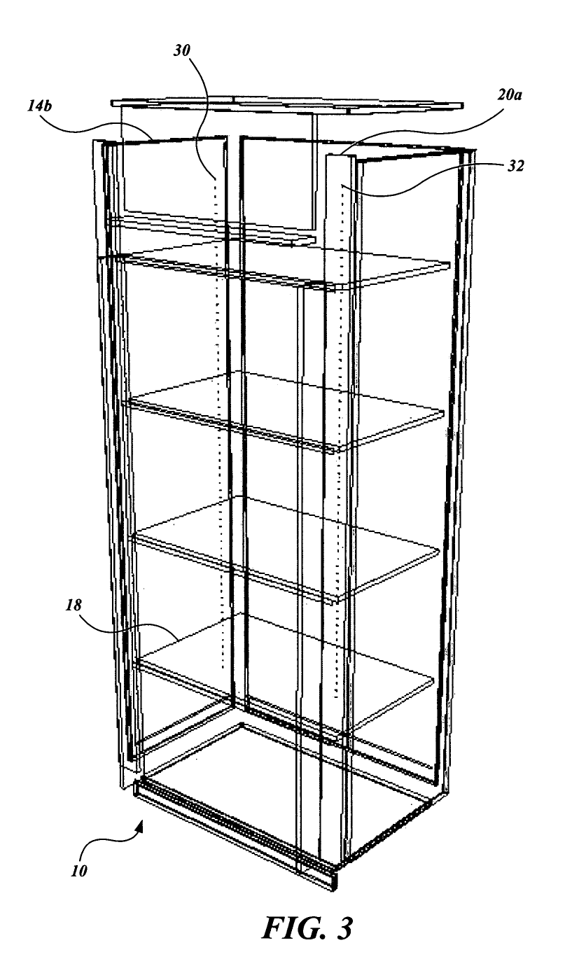

FIG. 3 is a transparent exploded view of a computer rendering of storage space 10 to help illustrate other characteristics of the components. For instance, a side wall 14b is illustrated with adjustment holes 30 that enable a shelf height can be adjusted. In addition, or alternatively, identifying marks can be used as recommended locations rather than pre-drilling the holes. For instance, a front surface 20a can include marks 32 to indicate where shelf height holes can be drilled to adjust the height of the shelves. The marks can be pre-placed on each component that will support a portion of the shelf, so that an installer or the final user can simply count the marks on each component rather than make multiple measurements and marks on the static elements to ensure that the shelf will be flat.

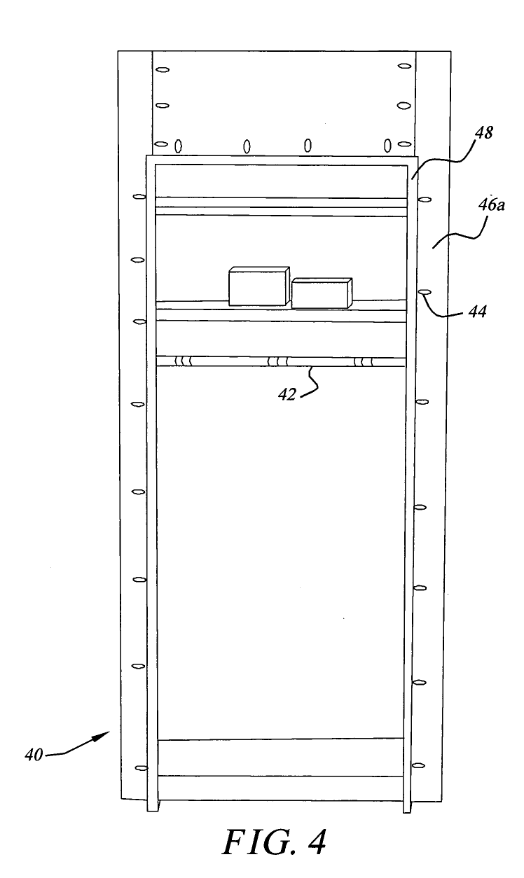

FIG. 4 is a front view of another exemplary embodiment in the form of a clothes closet 40. Clothes closet 40 is essentially a reconfiguration of storage space 10, in which some of the lower shelves are removed and a clothes rod 42 is installed. Clothes rod 42 is supported by the wall surfaces. FIG. 4 also illustrates a plurality of fastener locations, such as a pocket hole 44 through which a fastener can be used to attach a front surface 46 to a doorjamb 48. Closet 40 can be used as a reach-in closet or a walk-in closet, depending on a depth and/or shelf arrangement of closet 40.

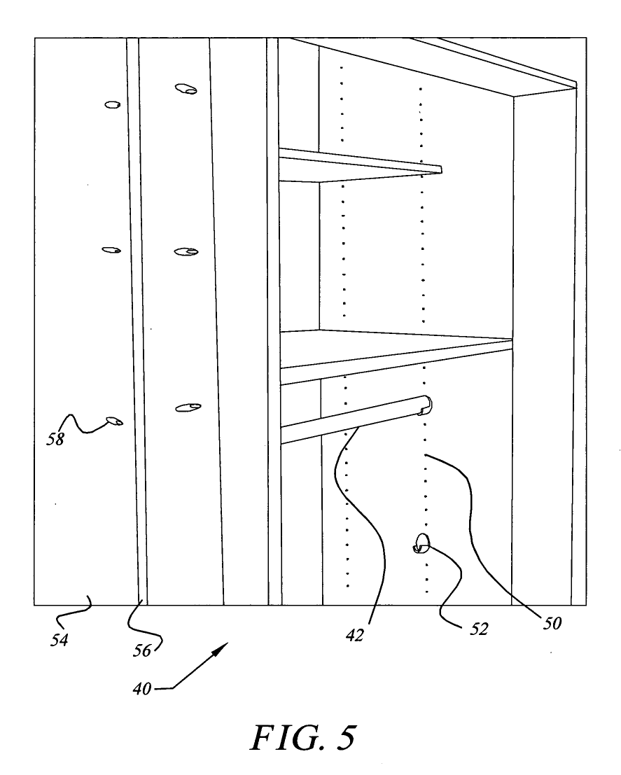

FIG. 5 is an isometric view of a portion of clothes closet 40. FIG. 5 shows holes 50 that can be used to adjust the height of clothes rod 42 and the shelves. For instance, a clothes rod bracket 52 can be installed in a different hole to support clothes rod 42 at a lower height. Other adjustable elements can be installed, such as a hook, an electrical fixture, a light, and the like. FIG. 5 also provides a closer view of how static surfaces are attached to each other. For example, a side wall 54 is attached to a front surface 56 via fasteners in pocket holes, such as a pocket hole 58. Other fastening techniques can be used, such as confirmats and the like.

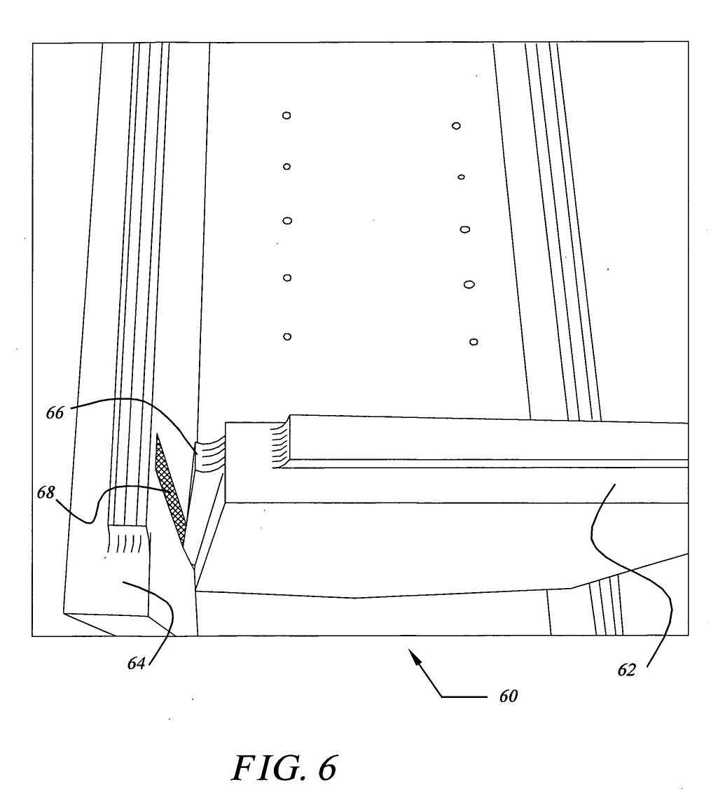

FIG. 6 is a close up view of a different storage space 60 that includes at least one fixed shelf 62 that is positioned at a fixed location within storage space 60. Fixed shelf 62 and a wall 64 are automatically prefabricated with a corresponding protrusion 66 and a slot 68 to form a blind dato attachment. Glue and/or fasteners can also be used to secure shelf 62 to wall 64.

### Exemplary Methods

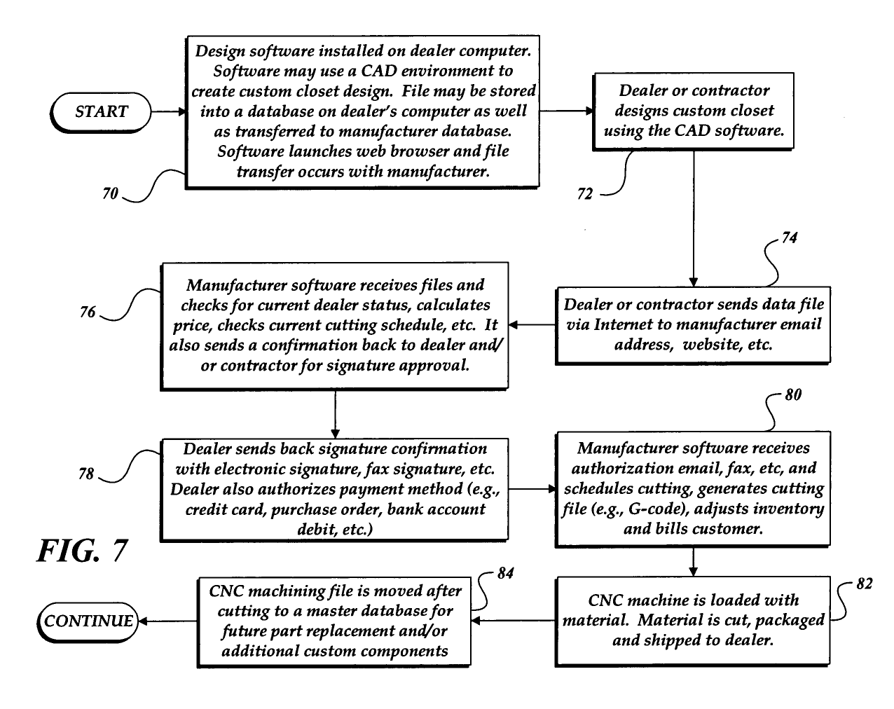

FIG. 7 is a flow diagram illustrating exemplary logic for designing and manufacturing a modular room. At an operation 70, design software conforming to the present invention is installed on a user's computer, such as a dealer's personal computer. The design software provides a command line environment and/or a computer aided design (CAD) environment in which a modular room can be defined. The installation process installs a number of files on the user's computer, including application programs and templates. A customer registration file can also be created and stored on the user's computer, stored in a database and/or communicated between the user and a software support service and/or a manufacturer.

At an operation 72, the user enters a number of room parameters through a graphical user interface to create a computer model of the desired modular room. The design software generates a realistic, three-dimensional (3D) representation of the desired modular room. For example, the design software can generate an image with holographic features for significant realism. The design software also generates a design data file that includes dimensions, materials, finishes, and other parameters of components of the desired modular room. The design data file can conform to a conventional file format, such as DXF, or comprise a proprietary format. At an operation 74, the user instructs the software to communicate the design data file to a manufacturer, such as Arrt Manufacturing, LLC that has corresponding manufacturing software installed.

The manufacturer receives the design data file at an operation 76 and the manufacturing software checks the file for valid user status. The manufacturing software also calculates a price, cutting schedule, and/or other manufacturing information based on the design data file. The manufacturing software can further send a confirmation to the user, indicating a status and/or requesting formal approval to begin producing the modular room. At an operation 78, the user returns an authorization to begin production.

Upon receiving authorization, the manufacturing software prepares production data at an operation 80. For example, the manufacturing software uses the design data to schedule one or more machines for efficient production of various components of the modular room. The scheduling can also account for production of multiple modular rooms from the same, or multiple customers. The manufacturing software also uses the design data to generate CNC code, such as G-code, for each machine involved in cutting, drilling, sanding, and/or otherwise creating the components of the modular room. Based on the components to be produced, the manufacturing software can determine the raw materials required and adjust an inventory to commit and/or order those raw materials. Correspondingly, the manufacturing software can generate a bill of materials and/or financial bill to the user. This billing can be done directly by the manufacturing software and/or in conjunction with another billing application.

At an operation 82, the generated CNC code is communicated to a computer controlled machine, and raw materials are loaded into the computer controlled machine. The computer controlled machine performs its cutting, drilling, sanding, and/or other manufacturing operation based on the CNC code. The resulting components can then be packaged and delivered to the user and/or the building site. The CNC code is stored in a database at an operation 84 so that the code can be reused at a later time if desired.

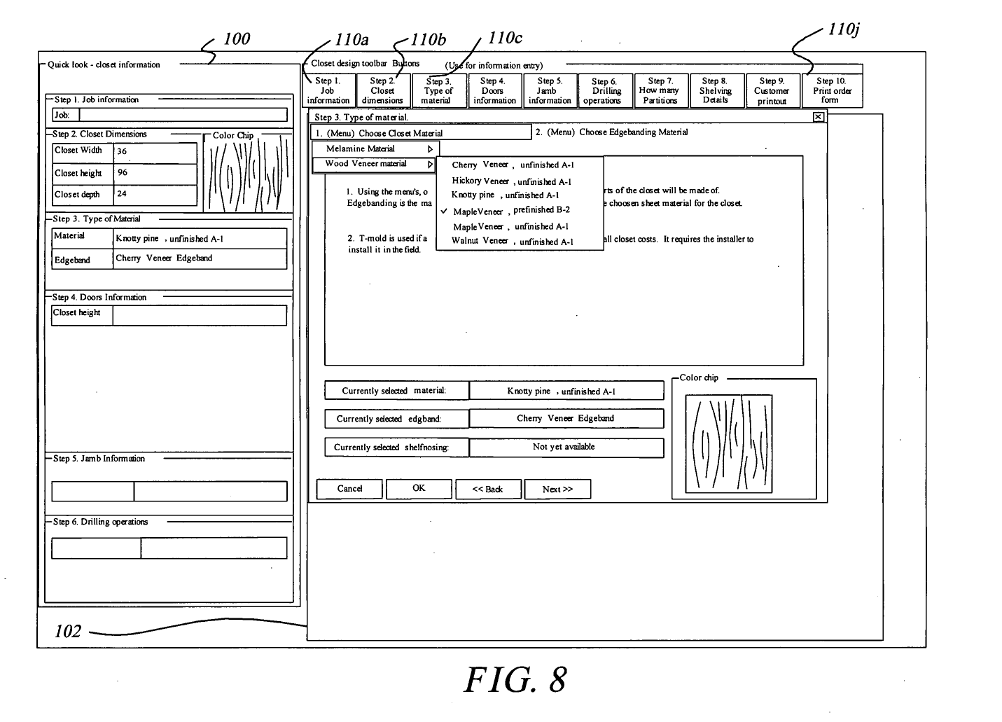

FIG. 8 is a screen shot of an exemplary user interface for design software. The software can be implemented as a Microsoft Windows™ application and/or other program. The user interface can be divided into a number of frames. For example, a quick look frame 100 can provide a summary of information regarding the modular room being designed. A visualization frame 102 can be used to display a wireframe model, a solid model, and/or a realistic, 3D representation of the modular room based on design parameters entered. The design parameters can be entered through a number of menu items and/or windows corresponding to a plurality of selectable buttons 110a through 110j. For example, a window 120 can provide instructions, menu options, sample illustrations, data entry/display fields, and the like for the user to select one or more materials for the modular room.

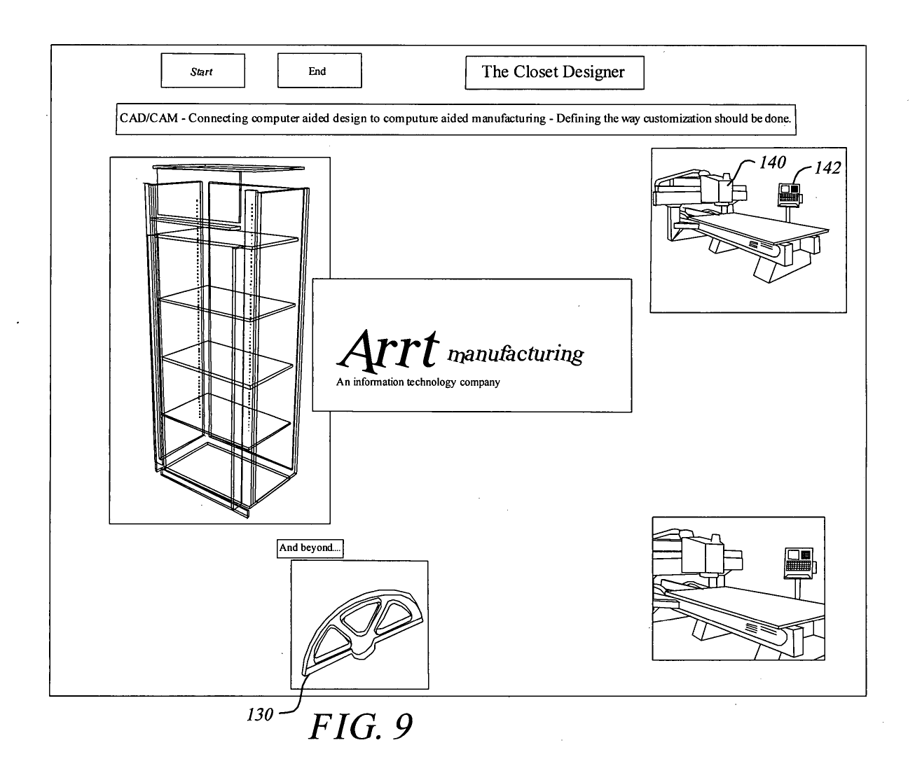

FIG. 9 is an introductory screen shot displayed upon initiation of the design software. The introductory screen shot illustrates sample wireframe, solid, and 3D representations of modular room components. For example, a sample 3D representation 130 illustrates shading characteristics that provide a 3D holographic effect for visualizing a component. The introductory screen also illustrates sample computer controlled machines, such as a CNC machine 140, that fabricate components based on the CNC code. Such computer controlled machines can perform one or more of the cutting, drilling, sanding, and/or other operations. The operations are controlled by a controller, such as a controller 142.

### Exemplary Computing Environment

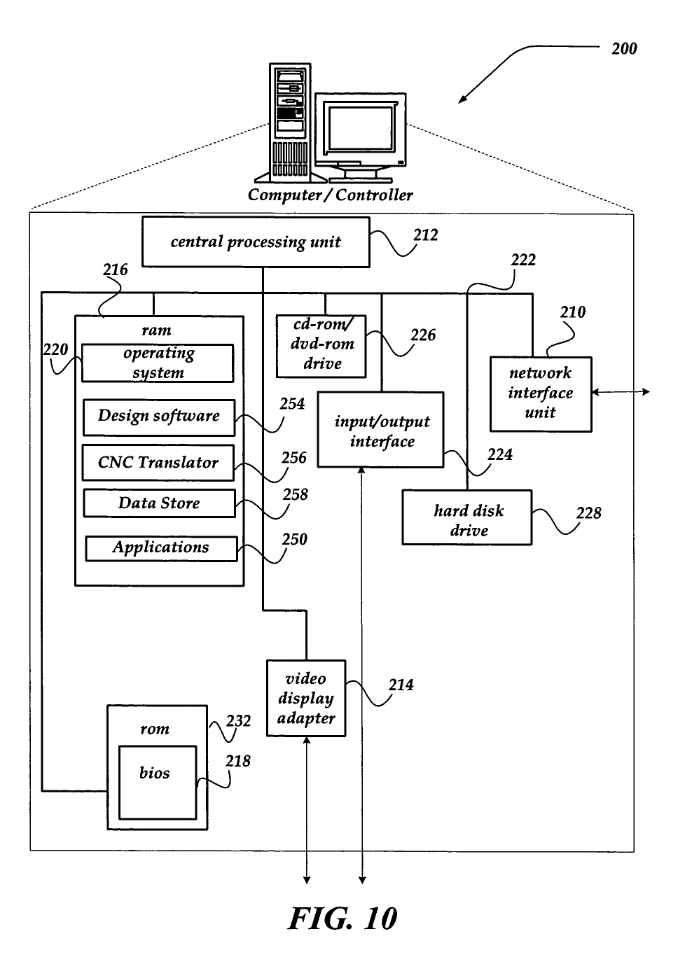

The controller and the computer for running the design software can be in network communication and can comprise similar components. FIG. 10 is a block diagram illustrating an exemplary embodiment of a computer and/or controller according to one embodiment of the invention. A computing device 200 may include many more components than those shown. The components shown, however, are sufficient to disclose an illustrative embodiment for practicing the invention.

Computing device 200 includes a processing unit 212, a video display adapter 214, and a mass memory, all in communication with each other via a bus 222. The mass memory generally includes a RAM 216, a ROM 232, and one or more permanent mass storage devices, such as a hard disk drive 228, tape drive, optical drive, and/or floppy disk drive. The mass memory stores an operating system 220 for controlling the operation of computing device 200. Any general-purpose operating system may be employed. Basic input/output system (“BIOS”) 218 is also provided for controlling the low-level operation of computing device 200. As illustrated in FIG. 10, computing device 200 also can communicate with the Internet, or some other communications network, such as an intranet, via network interface unit 210, which is constructed for use with various communication protocols including the TCP/IP protocol. Network interface unit 210 is sometimes known as a transceiver, transceiving device, network interface card (NIC), and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs include email programs, schedulers, calendars, web services, transcoders, database programs, word processing programs, spreadsheet programs, and so forth. Mass storage may further include applications such as design software 254, CNC translator 256, and a data store 258. Data store 258 may include a database, text, folder, file, a Universal Resource Locator (URL) and the like, that is configured to maintain and store the design parameters, CNC code, and the like.

Although illustrated in FIG. 10 as distinct components in computing device 200, the software and hardware components may be arranged, combined, and the like, in any of a variety of ways, without departing from the scope of the present invention. Computing device 200 may also include an SMTP handler application for transmitting and receiving email. Computing device 200 may also include an HTTP handler application for receiving and handing HTTP requests, and an HTTPS handler application for handling secure connections. The HTTPS handler application may initiate communication with an external application in a secure fashion.

Computing device 200 also includes input/output interface 224 for communicating with external devices, such as a mouse, keyboard, scanner, or other input devices not shown in FIG. 10. Likewise, computing device 200 may further include additional mass storage facilities such as CD-ROM/DVD-ROM drive 226 and hard disk drive 228. Hard disk drive 228 is utilized to store, among other things, application programs, databases, design software 254, CNC translator 256, data store 258, and the like.

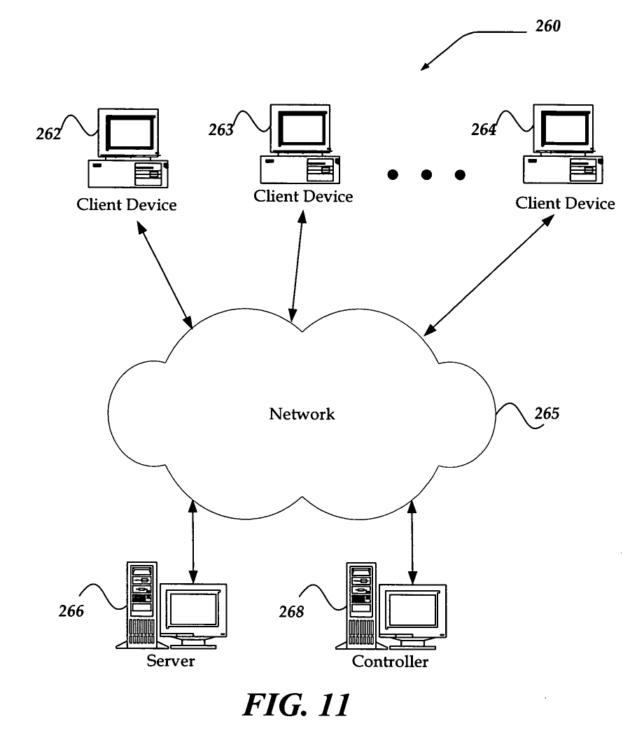

FIG. 11 illustrates one embodiment of an electronic network environment in which the present invention may operate. However, not all of these components may be required to practice the invention, and variations in the arrangement and type of the components may be made without departing from the spirit or scope of the invention.

As shown in the figure, a system 260 includes client devices 262-264, a network 265, a server 266, and a controller 268. Network 265 is in communication with and enables communication between each of client devices 262-264, server 266 and controller 268.

Client devices 262-264 may comprise design work stations, distributor computers, manufacturing scheduling, control, and quality assurance systems, and the like. Client devices 262-264 may include virtually any computing device capable of receiving and sending a message over a network, such as network 265, to and from another computing device, such as server 266, controller 268, each other, and the like. The set of such devices may include devices that are usually considered more general purpose devices and typically connect using a wired communications medium such as personal computers, multiprocessor systems, microprocessor-based or programmable consumer electronics, network PCs, and the like. Similarly, the set of such devices may also include any device that is capable of connecting using a wired or wireless communication medium such as a personal digital assistant (PDA), POCKET PC, wearable computer, and any other device that is equipped to communicate over a wired and/or wireless communication medium. Client devices 262-264 may further include mobile terminals that are usually considered more specialized devices and typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like.

Each client device within client devices 262-264 includes a user interface that enables a user to control settings, such as presence settings, and to instruct the client device to perform operations. Each client device also includes a communication interface that enables the client device to send and receive messages from another computing device employing the same or a different communication mode, including, but not limited to email, SMS, MMS, IM, internet relay chat (IRC), Mardam-Bey's internet relay chat (mIRC), Jabber, and the like. Client devices 262-264 may be further configured with a browser application that is configured to receive and to send web pages, web-based messages, and the like. The browser application may be configured to receive and display graphics, text, multimedia, and the like, employing virtually any web based language, including, but not limited to Standard Generalized Markup Language (SGML), HyperText Markup Language (HTML), Extensible Markup Language (XML), a wireless application protocol (WAP), a Handheld Device Markup Language (HDML), such as Wireless Markup Language (WML), WMLScript, JavaScript, and the like.

Network 265 is configured to couple one computing device to another computing device to enable them to communicate. Network 265 is enabled to employ any form of medium for communicating information from one electronic device to another. Also, network 265 may include a wireless interface, such as a cellular network interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize cellular telephone signals over air, analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 265 includes any communication method by which information may travel between client devices 262-264, server 266 and/or controller 268. Network 265 is constructed for use with various communication protocols including transmission control protocol/internet protocol (TCP/IP), WAP, code division multiple access (CDMA), global system for mobile communications (GSM), and the like.

The media used to transmit information in communication links as described above generally includes any media that can be accessed by a computing device. Computer-readable media may include computer storage media, wired and wireless communication media, or any combination thereof. Additionally, computer-readable media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wireless media such as acoustic, RF, infrared, and other wireless media, and wired media such as twisted pair, coaxial cable, fiber optics, wave guides, and other wired media.

Server 266 may act as a web server, general network server, provide central distribution of design software and/or services to the client devices, and the like. Server 266 may also provide tracking, storage, scheduling, inventory management, billing, accounting, and/or other services. Controller 268 may control one or more manufacturing machines, convert design data to computer numerical control data, and/or provide other manufacturing services.

### Additional Embodiments

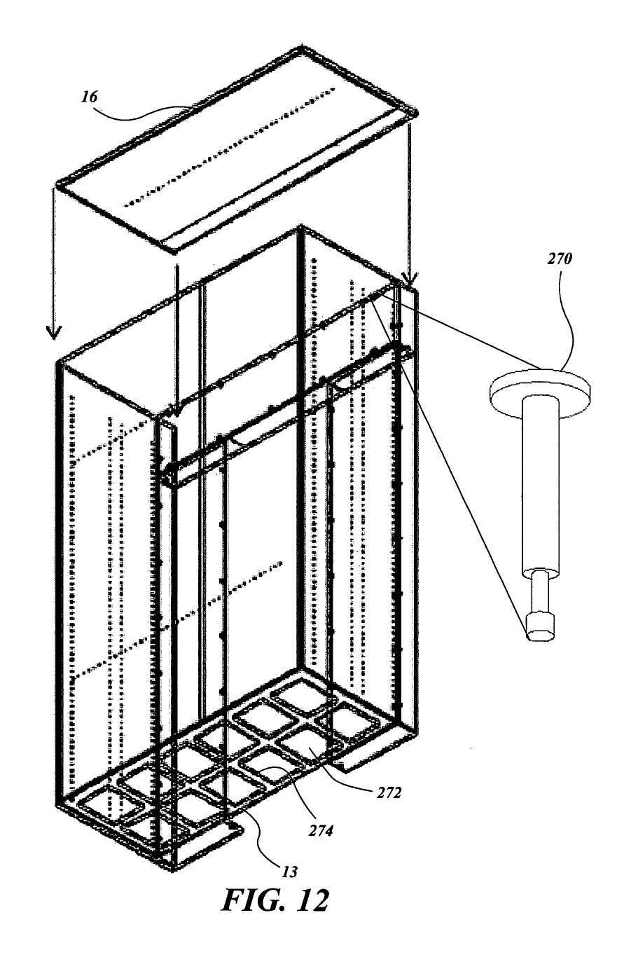

FIG. 12 is a transparent perspective view of an embodiment of the invention with a configurable subfloor 13. As with the walls, the ceiling, a finished floor (e.g., floor 12 of FIG. 1), and other components, subfloor 13 may comprise a wood, a laminate, a plastic, a metal, a composite, and/or other material. Similarly, the subfloor may be solid, solid core, hollow core, or combinations. The subfloor may be used in addition to a finished floor (e.g., floor 12 of FIG. 1), or may comprise the only floor. Exemplary subfloor 13 comprises a structural grid, including one or more openings, such as opening 272, and one or more cross members, such as cross member 274. One or more of the cross members and/or peripheral members may be removed if desired, to expose a floor under the modular room. Alternatively, or in addition, one or more cross members may be removed to provide a hidden storage area under a finished floor, such as floor 12 of FIG. 1. Similarly, wiring, conduit, a hidden door and/or other components may be incorporated in the area of the subfloor.

The subfloor may also be used to support the walls, a door, trim pieces, and/or other components. In addition to fasteners, or as alternatives to fasteners, one or more or pins, such as pin 270, may be placed into holes in the subfloor, the walls, and/or the ceiling to ease assembly and/or fasten the components together. For example, pins may be vertically inserted partially into subfloor 13 to support the walls. Pins may be horizontally inserted into holes in the walls to support and/or fasten each other. As shown, pins may also be vertically inserted partially into holes in ceiling 16 such that an exposed part of the pins can be inserted into holes in the top edges of the walls and back panel(s). The pins may also be inserted into cams or other devices that can secure the pins. A sample pin includes a part number 02.7165.001.30 provided by Peter Meier, Inc.

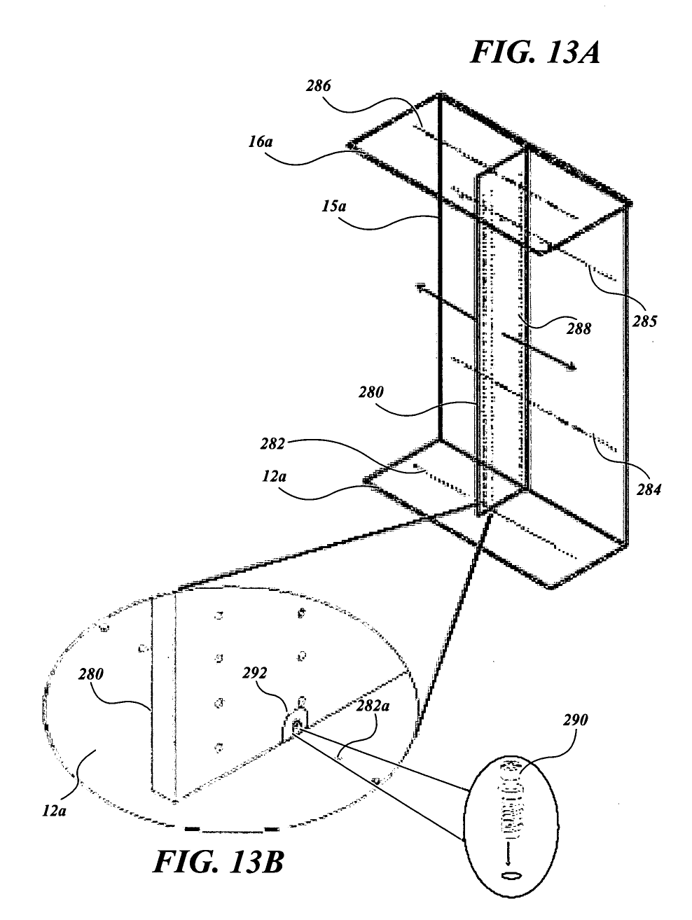

FIG. 13A is a transparent perspective view of another embodiment that includes a movable partition 280. In this exemplary embodiment, partition 280 may be repositioned horizontally between a floor 12a and a ceiling 16a. However, those skilled in the art will recognize that other movable components may be used, such as a shelf that may be repositioned vertically between walls, a drawer that may be repositioned horizontally or vertically on a back panel 15a, and the like. Support components, such as the floor, ceiling and walls, include position holes at which the partition (or other movable component) may be positioned. For example, floor 12a includes a longitudinal set of position holes 282; back panel 15a includes two horizontal rows of position holes 284 and 285; and ceiling 16a includes a longitudinal row of position holes 286.

FIG. 13B is a magnified view of an area at which partition 280 interfaces with floor 12a. Some of the longitudinal position holes of floor 12a are shown, such as position hole 282a. A fastener, such as a screw-in dowel 290, is partially inserted into a position hole of the support component at a desired partition location. A sample screw-in dowel includes a part number 6710 provided by Titus International Plc. An exposed part of the fastener is coupled to a securing component, such as a cam 292, that is attached to the partition. In this exemplary embodiment, the securing component may be a connector with part number 06451 or 06453, provided by Titus International Plc. The securing component is tightened, or otherwise adjusted, to secure the partition to the fastener. One or more additional fasteners and securing components may be used to further secure the partition to the floor and/or the ceiling.

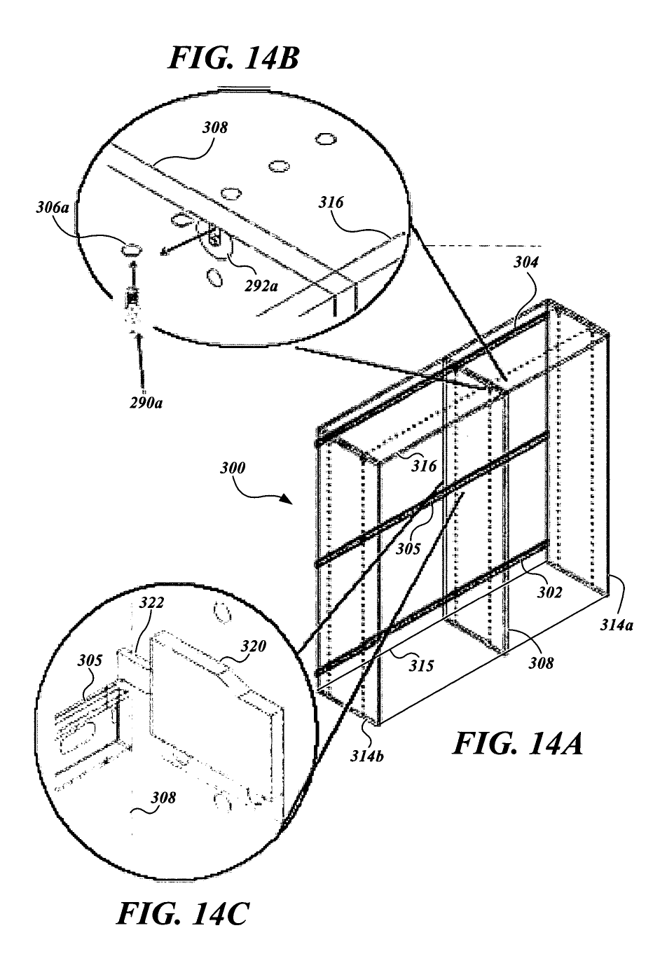

FIG. 14A is a transparent perspective view of yet another embodiment that provides one or more moveable partitions that are coupled to adjacent surfaces rather than opposite surfaces. This embodiment comprises a modular space 300 with walls 314a and 314b, a back panel 315, a ceiling 316, and a movable partition 308. One or more rails are attached to a surface so that a partition, shelf, drawer, or other object may be repositioned. For example, rails 302, 304, and 305 are horizontally attached to back panel 315. Partition 308 can then be coupled to the rails at any position between walls 314a and 314b.

As shown in FIG. 14B, a top portion of partition 308 is also coupled to ceiling 316 in a fashion similar to that described with regard to FIG. 13B. FIG. 14B is a magnified view of an area at which partition 308 interfaces with ceiling 316. Some longitudinal position holes of ceiling 316 are shown, such as position hole 306. A fastener, such as a screw-in dowel 290a, is partially inserted into a position hole of the ceiling at a desired partition location. An exposed part of the fastener is coupled to a securing component, such as a cam 292a, that is attached to the partition. The securing component is tightened, or otherwise adjusted, to secure the partition to the fastener. One or more additional fasteners and securing components may be used to further secure the partition to the ceiling.

Rather than securing a bottom portion of the partition to the floor, in this embodiment, a longitudinal portion of partition 308 is coupled to one or more of the rails. FIG. 14C is a magnified view of an area at which partition 308 couples to railing 305. A hanging bracket 320 is attached to a wide surface of partition 308 near an edge adjacent to the back panel. Hanging bracket 320 includes an “L-arm” 322 that hooks over a flange of rail 305. A sample rail 305 may be part number 875-Z1-24 provided by Peter Meier, Inc. A sample hanging bracket 320 may be part numbers 16.85450, 16.85451, or the like provided by Peter Meier, Inc.

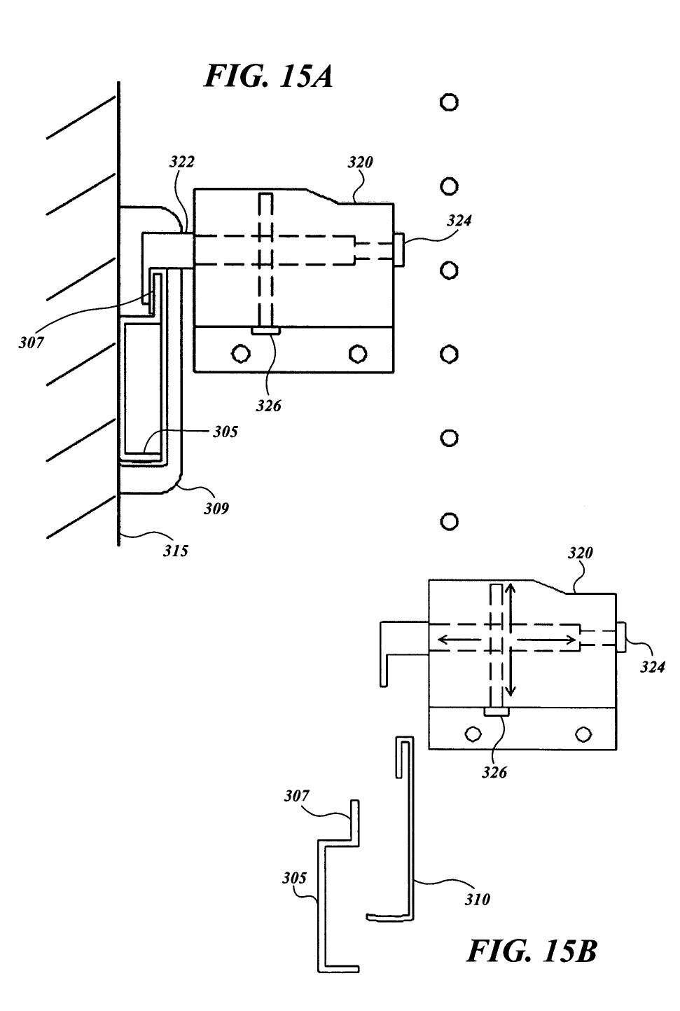

FIG. 15A is a side view of another embodiment that couples a partition to a surface such as back panel 315. To press fit the partition against the back panel, a notch 309 is cut out of the partition such that rail 305 can run through notch 309 and a back edge of the partition can be placed directly adjacent to back panel 315. Once L-arm 322 is in position over a flange 307 of rail 305, a horizontal adjustment 324 of hanging bracket 320 may be tightened to pull the partition toward back panel 315. Similarly, a vertical adjustment 326 of hanging bracket 320 may be tightened to pull notch 309 toward rail 315 to further secure the partition in position.

FIG. 15B is an exploded view of the exemplary coupling components for further understanding. L-arm 322 extends into a housing of hanging bracket 320, where the L-arm interfaced with horizontal adjustment 324 and vertical adjustment 326. A rail cover 310 may be fitted over flange 307 of rail 305 to conceal holes and/or fasteners (not shown) within a channel of rail 305 that fasten rail 305 to the back panel. L-arm 322 of hanging bracket 320 would be placed over rail cover 310 and flange 307 of rail 305.

The above specification, examples and data provide a complete description of the manufacture and use of the composition of the invention. Since many embodiments of the invention can be made without departing from the spirit and scope of the invention, the invention resides in the claims hereinafter appended.

1. A modular space system comprising:
a plurality of load bearing wall surfaces that can interface with a frame of a building structure;
a floor that can be attached to the plurality of load bearing wall surfaces, wherein the floor can couple to the frame of the building structure; and
a ceiling that can be attached to the plurality of load bearing wall surfaces, wherein the plurality of load bearing wall surfaces, the floor, and the ceiling are configured to be assembled separate from the frame of the building structure, and form an opening to access an interior of the modular space system.

2. The modular space system of claim 1, wherein the modular space system comprises one of a reach-in closet and a walk-in a closet.

3. The modular space system of claim 1, wherein the plurality of load bearing wall surfaces include at least one support for at least one of the following; a shelf, a hanger rod, an electrical fixture, and a partition.

4. The modular space system of claim 3, further comprising at least one of the following; a shelf, a hanger rod, an electrical fixture, and a partition.

5. The modular space system of claim 1, wherein the ceiling includes a support for an electrical fixture.

6. The modular space system of claim 3, wherein the at least one support provides multiple, adjustable positions for the one of the shelf, the hanger rod, and the partition.

7. The modular space system of claim 3, further comprising:
a fastener inserted in one of a plurality of holes in at least one of the following:
at least one of the plurality of load bearing wall surfaces;
the floor; and
the ceiling; and
a securing device attached to one of the following; the shelf, the hanger rod, and the partition, such that the securing device couples to the fastener to secure the one of the shelf, the hanger rod, and the partition in one of a plurality of positions.

8. The modular space system of claim 3, further comprising:
a rail attached to one of the plurality of load bearing wall surfaces; and
a coupler attached to one of the following; the shelf and the partition, such that the coupler couples to the rail to secure the one of the shelf and the partition in one of a plurality of positions.

9. The modular space system of claim 8, wherein the coupler includes at least one adjustment that enables the one of the shelf and the partition to be moved into contact with at the one of the plurality of load bearing surfaces.

10. The modular space system of claim 1, wherein the floor comprises at least one of the following; a finished floor and a subfloor.

11. The modular space system of claim 10, wherein the subfloor comprises a grid of cross members.

12. The modular space system of claim 11, wherein at least one of the cross members is removed.

13. The modular space system of claim 1, further comprising a trim for attaching to the load bearing wall surfaces around the opening.

14. The modular space system of claim 1, further comprising a door jamb for spanning the opening.

15. The modular space system of claim 1, further comprising a non-load bearing wall surface for coupling to at least one of the load bearing wall surfaces.

16. The modular space system of claim 1, further comprising fasteners that can couple the floor and the ceiling to the plurality of load bearing wall surfaces, and that can attach the plurality of load bearing wall surfaces to each other.

17. A modular enclosure comprising:
a plurality of load bearing wall surfaces that interface with a frame of a building structure,
a floor attached to the plurality of load bearing wall surfaces, wherein the floor can couple to the frame of the building structure; and
a ceiling attached to the plurality of load bearing wall surfaces, wherein the plurality of load bearing wall surfaces, the floor, and the ceiling are assembled separate from the frame of the building structure, and form an opening to access an interior of the modular enclosure.

18. A method for producing a modular space system comprising:
providing an electronic user interface that enables a user to specify parameters defining at least:
a plurality of load bearing wall surfaces that can interface with a frame of a building structure;
a floor for attaching to the plurality of load bearing wall surfaces, wherein the floor can couple to the frame of the building structure;
a ceiling for attaching to the plurality of load bearing wall surfaces, wherein the plurality of load bearing wall surfaces, the floor, and the ceiling can be assembled separate from the frame of the building structure, and
an opening to access an interior of the modular space system;
communicating at least a portion of the parameters to a manufacturing system; and
producing the plurality of load bearing walls, the floor, and the ceiling with the manufacturing system.

19. The method of claim 18, further comprising:
assembling the modular space system from the plurality of load bearing walls, the floor, and the ceiling; and
coupling the modular space system to a frame of a building structure.

20. The method of claim 18, wherein the electronic user interface includes:
a quick look frame that provides a summary of information defining a design of the modular space;
a visualization frame that displays a representation of the modular space; and
a data entry field that enables a user to enter the information.

21. The method of claim 18, wherein the user interface is implemented through one of a browser and a client application.

22. The method of claim 18, wherein the parameters comprise at least one of dimensions, a material, and a color.

23. The method of claim 18, wherein communicating at least a portion of the parameters is performed over a network.

24. The method of claim 23, wherein the parameters are communicated to a server for communication to a manufacturing machine.

25. The method of claim 18, wherein the manufacturing system comprises a computer controlled machine.

26. A method for managing information for a modular space system, comprising:
displaying a user interface on an electronic display, wherein the user interface includes:
a quick look frame that provides a summary of information defining a design of the modular space;
a visualization frame that displays a representation of the modular space; and
a data entry field that enables a user to enter the information defining the design of the modular space;
detecting entry of the information regarding design of the modular space system; and
communicating the information to a manufacturing system to produce the modular space system comprising:
a plurality of load bearing wall surfaces that can interface with a frame of a building structure;
a floor that can be attached to the plurality of load bearing wall surfaces, wherein the floor can couple to the frame of the building structure; and
a ceiling that can be attached to the plurality of load bearing wall surfaces, wherein the plurality of load bearing wall surfaces, the floor, and the ceiling are configured to be assembled separate from the frame of the building structure, and form an opening to access an interior of the modular space system.

27. A computer readable medium, comprising executable instructions for performing a plurality of actions, including the actions of claim 26.
